(19) United States
(12) Patent Application Publication
(10) Pub. No.: US 2021/0356415 A1
(43) Pub. Date: Nov. 18, 2021

(54) LARGE-SCALE COEFFICIENT OF THERMAL EXPANSION SYSTEMS AND RELATED METHODS

(71) Applicant: University of Tennessee Research Foundation, Knoxville, TN (US)

(72) Inventor: Chad Edward Duty, Loudon, TN (US)

(21) Appl. No.: 16/875,650

(22) Filed: May 15, 2020

(51) Int. Cl. G01N 25/16

(52) U.S. Cl. CPC G01N 25/16

(57) ABSTRACT

Systems and methods are provided for measuring the linear coefficient of thermal expansion or characterizing other physical properties of large-scale printed parts in various directions using digital image correlation techniques. Such system and methods can involve positioning a sample in a temperature-controllable chamber comprising a viewport in a bottom of the chamber, capturing a plurality of images of a bottom surface of the sample, and characterizing one or more physical property of the sample based on the plurality of images. As a result, a single camera is able to accurately capture the relevant strain measurements to determine the properties of the sample.

### TECHNICAL FIELD

The presently disclosed subject matter relates to systems and methods for determining a coefficient of thermal expansion of a material sample. In some embodiments, the present subject matter relates to determining large-scale coefficients of thermal expansion.

### BACKGROUND

Extrusion deposition additive manufacturing (EDAM) allows the rapid creation of parts with complex geometries using systems ranging from a desktop fused filament fabrication (FFF) printer to large-area extrusion deposition machines, including the University of Tennessee Manufacturing Demonstration Facility's (MDF) Big Area Additive Manufacturing (BAAM) system. There are opportunities for implementation of additive manufacturing in the aerospace, dental, and medical fields [1-3]. One opportunity of significant interest is the manufacturing of tooling for composites, which commonly have complex geometries and long lead times. Previous works on the practicality of state-of-the-art technologies have shown the use of additive manufacturing (AM) processes can reduce lead time and cost of manufacturing tooling [4-8].

Some tooling, such as those used in autoclaves, can undergo temperature change during the production of the composites. This means the thermomechanical behavior of the tooling are important, for if the linear coefficients of thermal expansion (LCTE) of the tooling and the composite being produced from the tooling are mismatched, then the composite will have distortion that could render the part unusable [9]. As applications for printed molds move toward higher temperatures, it thus becomes increasingly important to characterize the thermal expansion in multiple directions to predict and manage warping & distortion.

Further complicating this issue, parts manufactured using FFF or extrusion deposition additive manufacturing are created by depositing beads of material into the desired shape to create one layer in the x-y plane, raising the extruding nozzle, and depositing another layer on top of the previous one. The path the nozzle takes to deposit the beads to make these layers is referred to as the toolpath. The toolpath for an AM part comes in many forms: rectilinear, concentric, honeycomb and many others. The combination of all the beads in each layer create the macrostructure of the part. The macrostructure determines the thermomechanical properties of the part as a whole, as it defines the amount of bulk material and bead to bead interfaces being strained. Additively manufactured parts thus have an inherent mesostructure as a result of printing artifacts. The build structure is defined by parameters such as infill pattern, raster spacing, and bead height, and can impart anisotropic thermo-mechanical properties that are different from the bulk properties of the feedstock. Cited works have documented anisotropy due to macrostructure [10-13].

In addition, the anisotropy can be more pronounced when printing with fiber reinforced polymers due to the shear-alignment of fibers during the extrusion process. For instance, the anisotropy from the macrostructure is heightened when the feedstock for the part is a carbon fiber reinforced polymer, which is critical in large area extrusion deposition additive manufacturing (LAEDAM), such as the BAAM, for reducing distortion [14, 15]. Anisotropy increases due to the stiffness of the fibers embedded in the matrix material. The fiber-matrix interface allows thermal and mechanical stresses to be transferred from the matrix to the fibers [16]. Therefore, the amount of stress that can be transferred to a fiber in a direction will affect mechanical and thermomechanical properties. The amount of transferrable stress determines the composite's properties and will be a function of aspect ratio, fiber orientation and the fiber-matrix interface [17, 18].

During printing, fibers primarily align in the print direction of the bead, which is due to the shear forces experienced by the material during extrusion [19, 20]. Although the majority of the fibers align in the print direction, fiber orientation does vary throughout a bead. Fibers are more oriented in the print direction near the outside perimeter of the bead and more randomly oriented towards the center, leading to anisotropy within the bead itself [21]. Therefore, a part produced using LAEDAM will have anisotropy from both micro- and macro-scale features, and as fibers align with print direction, which is part of the macrostructure, the two become intertwined [20].

For these reasons, it can be difficult to accurately measure the LCTE of a part having this kind of anisotropy on the macroscale. Most conventional CTE measurement systems are based on physical touch sensors (LVDT) or laser interferometry and are designed to provide very precise measurements. Unfortunately, all of the CTE systems presently in industry are used for small sample sizes (˜10 mm)—operating under the assumption that the properties of a small sample are equivalent to the bulk properties.

For materials made by 3D printing, however, internal geometries and material variations are possible that can have significant impact on the apparent bulk properties, such as the extrusion-based 3D printed materials having a natural mechanical anisotropy associated with shear-induced alignment of polymer molecules or reinforcing fibers, and the CTE in the extrusion direction (x-axis) often being up to 10× lower than the corresponding CTE perpendicular to the flow (z-axis), using small scale measurements. Thus, when materials with highly anisotropic mechanical properties are deposited in unique patterns using 3D printing (such as sparse infills, cross-plies, or spiral infills) the overall component performance can be drastically different than that predicted from small scale material measurements.

For these reasons, the traditional LCTE testing standard, ASTM E831-14, which is intended for a sample of less than ten millimeters in any direction, can be a poor estimate of the LCTE of a part as a whole, even if it is accurate for measuring LCTE of the beads that form the macrostructure [22]. As a result, there exists a need for systems and methods to more accurately characterize the thermal expansion coefficients of the overall structure so the distortion properties of a printed products can be predicted. This is particularly important for large-scale autoclave tooling where dimensional stability is critical over temperature ranges of ˜200 C.

### SUMMARY

In accordance with the presently disclosed subject matter, systems and methods for determining a linear coefficient of thermal expansion and/or characterizing one or more other physical property of a sample are described herein. In one aspect, a system for determining physical properties of a sample includes a temperature-controllable chamber comprising a platform having an opening therethrough and a viewport in a bottom of the chamber, a camera positioned beneath the chamber, a temperature control system in communication with the chamber and configured to modulate a temperature within the chamber, and a measurement and control system in communication with the camera. With this configuration, the camera is configured to capture a plurality of images of a sample positioned on the platform over the opening, and the measurement and control system is configured to characterize one or more physical property of the sample based on the plurality of images.

In another aspect, a method for determining physical properties of a sample includes positioning a sample in a temperature-controllable chamber comprising a viewport in a bottom of the chamber, capturing a plurality of images of a bottom surface of the sample, and characterize one or more physical property of the sample based on the plurality of images.

Thus, it is an object of the presently disclosed subject matter to provide systems and methods for measuring physical properties of large-scale printed parts. An object of the presently disclosed subject matter having been stated herein above, and which is achieved in whole or in part by the presently disclosed subject matter, other objects will become evident as the description proceeds when taken in connection with the accompanying Figures as best described herein below.

### BRIEF DESCRIPTION OF THE DRAWINGS

Preferred embodiments of the drawings will now be described of which:

FIG. 1 is a schematic side view of a conventional digital image correlation testing arrangement;

FIG. 2 is a schematic side view of a digital image correlation testing arrangement according to an embodiment of the presently-disclosed subject matter;

FIG. 3 is micrograph of a bead of a sample of fiber-reinforced material produced by an additive manufacturing system showing varied fiber orientation;

FIG. 4 is a graph of thermal expansion measured between 30° C. and 85° C. of a small-scale sample of fiber-reinforced material produced by an additive manufacturing system;

FIGS. 5A and 5B are strain maps of a 0-0 cube at 90° C. in an x-direction and a y-direction, respectively, generated using a method according to the presently-disclosed subject matter;

FIGS. 6A and 6B are strain maps of a 0-90 cube at 90° C. in an x-direction and a y-direction, respectively, generated using a method according to the presently-disclosed subject matter; and

FIG. 7 is a graph of average strain measured in each of ninety photos using a method according to the presently-disclosed subject matter.

### DETAILED DESCRIPTION

The present subject matter provides systems and methods for measuring the LCTE or other physical properties of large-scale printed parts in various directions using digital image correlation (DIC) techniques. The results of these measurements compare favorably against both conventional thermomechanical analysis (TMA) of small-scale samples and theoretical predictions using composite laminate theory. In particular, in one aspect, the present subject matter provides a system that measures mechanical strain optically using conventional digital image correlation (DIC) technology. DIC is capable of measuring strain in two dimensions simultaneously by tracking visual markers (often a speckle pattern) on the surface of a sample. In some particular embodiments, the system is capable of measuring strains of sub-parts-per-million over a sample cube measuring 5 inches along a side, although since DIC is not limited to a specific sample size, the concept could be extended from millimeters to several meters.

### I. Definitions

While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art. While the following terms are believed to be well understood by one of ordinary skill in the art, the following definitions are set forth to facilitate explanation of the presently disclosed subject matter.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the presently disclosed and claimed subject matter.

Definitions of particular chemical terms are those that would be understood by one of ordinary skill in the art. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in, for example, Sorrell, 2006; Smith & March, 2001; Larock, 1989; and Carruthers, 1986; the entire contents of each of which are incorporated herein by reference.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

Following long-standing patent law tradition, the terms “a”, “an”, and “the” are meant to refer to one or more as used herein, including the claims. For example, the phrase “a composite material” can refer to one or more composite materials. Also as used herein, the term “another” can refer to at least a second or more.

The use of the term “or” in the claims is used to mean “and/or” unless explicitly indicated to refer to alternatives only or the alternatives are mutually exclusive.

Unless otherwise indicated, all numbers expressing quantities of ingredients, reaction conditions, and so forth used in the specification and claims are to be understood as being modified in all instances by the term “about”. The term “about”, as used herein when referring to a measurable value such as an amount of mass, weight, time, volume, concentration, or percentage, is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods and/or employ the disclosed compositions. Accordingly, unless indicated to the contrary, the numerical parameters set forth in this specification and attached claims are approximations that can vary depending upon the desired properties sought to be obtained by the presently disclosed subject matter.

As used herein, the term “and/or” when used in the context of a list of entities, refers to the entities being present singly or in combination. Thus, for example, the phrase “A, B, C, and/or D” includes A, B, C, and D individually, but also includes any and all combinations and subcombinations of A, B, C, and D.

The term “comprising”, which is synonymous with “including” “containing”, or “characterized by”, is inclusive or open-ended and does not exclude additional, unrecited elements and/or method steps. “Comprising” is a term of art that means that the named elements and/or steps are present, but that other elements and/or steps can be added and still fall within the scope of the relevant subject matter.

As used herein, the phrase “consisting of” excludes any element, step, or ingredient not specifically recited. It is noted that, when the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of the related disclosure or claim to the specified materials and/or steps, plus those that do not materially affect the basic and novel characteristic(s) of the disclosed and/or claimed subject matter.

With respect to the terms “comprising”, “consisting of”, and “consisting essentially of”, where one of these three terms is used herein, the presently disclosed and claimed subject matter can include the use of either of the other two terms.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

As used herein, “significance” or “significant” relates to a statistical analysis of the probability that there is a non-random association between two or more occurrences. To determine whether or not a relationship is “significant” or has “significance”, statistical manipulations of the data can be performed to calculate a probability, expressed as a “p-value”. Those p-values that fall below a user-defined cutoff point are regarded as significant. In some embodiments, a p-value less than or equal to 0.10, in some embodiments less than or equal to 0.05, in some embodiments less than or equal to 0.01, in some embodiments less than or equal to 0.005, and in some embodiments less than or equal to 0.001, are regarded as significant.

### II. Testing Systems

DIC is an optical method of measuring in-plane deformations of an object [23]. As illustrated in FIG. 1, in a conventional DIC testing arrangement, generally designated 10, a sample S to be measured sits inside of a temperature-controllable chamber 11, such as a heavily insulated oven, with one or more viewports 12 through which a camera 13 can observe the expansion of the sample S within the chamber 11. The sample S is either configured to have one or more distinct reference features that can be discretely identified using an optical imaging system, or the surface of the sample S is marked with an identifiable pattern, such as by applying paint that results in a random speckle pattern on the surface, whereby changes in the size or shape of the surface can be detected.

Conventional DIC measurements are generally taken from a viewport 12 positioned to the side of the sample S. In this configuration, significant noise is introduced into the measurement signal due to natural convection disturbances, generally designated C, moving up a side surface S0 of the sample S being measured, much in the way an object viewed from across a parking lot on a hot day appears wavy. Another problem with conventional DIC testing arrangements results from the three-dimensional nature of thermal expansion—meaning that the side surface S0 being interrogated is constantly moving away from (or toward) the camera. In the standard side-view arrangement, the side surface S0 of sample S is able to expand beyond the vertical plane at which strain was being measured originally, with the side surface S0 moving from an original position to an expanded position, generally designated S0′. Out of plane movement can introduce bias to the two-dimensional strain measurements. This expansion relative to the camera is typically addressed by using multiple cameras, such as in a 3D stereo-optical arrangement, and the out-of-plane movement is accounted for using a complex 3-dimensional strain calculation. Such a solution, however, requires that viewport 12 be widened or additional openings be provided in the chamber 11 to allow these multiple views of the sample S.

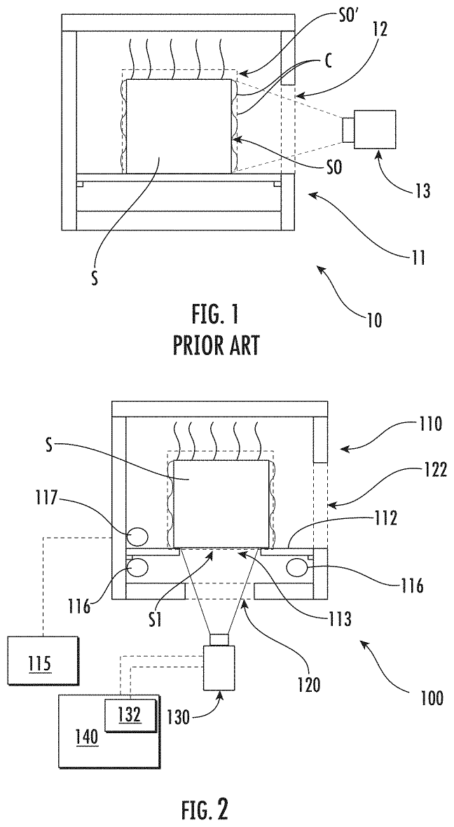

By comparison, the present subject matter provides a system that is configured to address these and other sources of distortion without complex correction calculations. As illustrated in FIG. 2, similar to the conventional configuration discussed above, a DIC testing arrangement, generally designated 100, includes a temperature-controllable chamber 110. In some embodiments, the temperature-controllable chamber 110 can include a specially-designed oven with a temperature control system, generally designated 115, which is configured to modulate a temperature within the chamber 110. In some experimental configurations, such a temperature control system was provided by Applied Testing Systems. In contrast to conventional systems, the chamber 110 has a viewport 120 in the bottom of the chamber 110 through which a bottom surface 51 of the sample S can be observed. In some embodiments, the viewport 120 simply exhibits transparency within the spectral range of the device used to interrogate the bottom surface 51, such as a camera 130 discussed below. It can be further advantageous, however, for the chamber 110 and/or the viewport 120 to be configured to limit or prevent reflections from external light sources into the chamber 110 that could interfere with imaging the bottom surface 51 of the sample S. In some embodiments, for example, the viewport 120 includes one or more anti-reflection coating. In addition, in some embodiments, the viewport is sized, shaped, or otherwise configured to help maintain a thermal environment within the chamber 110 as homogeneous as possible. In this regard, the viewport 120 can configured to minimize the introduction of relatively colder air into the chamber 110 through the viewport 120. In some embodiments, the viewport 120 is blocked by a cover (not illustrated) when the sample is not being interrogated to help prevent such interference with the thermal environment.

To keep the sample S positioned to enable this observation of its bottom surface S1, in some embodiments, the chamber 110 can include a platform 112 having an opening 113 therethrough. With this arrangement, the sample S can be positioned on the platform 112 over the opening 113 such that the bottom surface S1 is visible through the opening 113 and the viewport 120. In some embodiments, the opening 113 in the platform is a hole in the platform that is sized to be smaller than the sample S so that the sample S is supported at least partially by the platform 112. Alternatively, in some embodiments, the opening 113 can include a transparent window, such as a glass or polymer sheet, that can help support the sample S in place while still allowing the bottom surface S1 to be observed. In any configuration, the opening 113 is sized to allow a sufficient surface area of the sample S to be observed to accurately characterize the expansion of the sample S upon heating. Those having ordinary skill in the art will recognize that the opening 113 having a relatively larger size can allow for a larger portion of the bottom surface S1 to be observed, and thus the scale of the change in length of the measured dimensions can be correspondingly larger. In this way, a larger size of opening 113 can enable more measurements to be averaged together to improve the precision of a CTE measurement or other physical property measurement. That being said, the size of the opening 113 can be selected by balancing this benefit in observing a large sample area against considerations of the increased cost, reduced efficiency, and/or other characteristics associated with a correspondingly larger chamber 110.

Furthermore, in some embodiments, the material and/or configuration of the platform 112 and/or the opening 113 is selected to allow the sample to be substantially unconstrained in its position on platform 112. In this way, the expansion of the sample S is not unduly limited by friction or other forces that would introduce strains on the bottom surface that are unrelated to thermal expansion. For example, in some embodiments, it can be sufficient that the platform 112 has a smooth, substantially flat surface.

A camera 130 can be positioned beneath the chamber 110 to observe the expansion of a sample S within the oven 110. In some embodiments, it can be advantageous for the camera 130 to have a sufficient resolution to precisely capture the expansion of the sample S. In some experimental configurations, for example, a five-megapixel camera (e.g., Correlated Solutions CSI-5MP) was used. Those having ordinary skill in the art will recognize, however, that the camera 130 can have any of a range of characteristics that are sufficient to accurately image the bottom surface S1 of the sample S. In some configurations, the scale of a CTE that is being measured for the materials of interest is on the order of a part per million (ppm) per degree C., which corresponds to a scale of approximately a micron per meter per degree C. By way of example, in such configurations, a patterning of the bottom surface S1 using a pattern of dots that are approximately 100 microns can be appropriate to characterize the change in size of the sample S. In such an arrangement, for example, the camera 130 can be configured to have a resolution sufficient to resolve each dot and track the movement relative to other dots.

In some embodiments, the camera 130 can be arranged with respect to the chamber 110 to optimize the capture of a plurality of images of the bottom surface S1. In some embodiments, for example, the camera 130 is positioned at a distance from the bottom surface S1 of the sample S that is selected to balance the benefits of the camera being positioned as close as possible (e.g., such that the size of the viewport 120 can likewise be minimized to reduce its impact on the thermal environment within the chamber 110 as discussed above) while also being far enough away from the bottom surface S1 such that the camera 130 can produce both an acceptably sharp focus and a desired field of view of the bottom surface S1. In addition, in some embodiments, an opaque shield or cape (not illustrated) can be positioned around the camera to help prevent any reflections from external light sources from interfering with the observation of the bottom surface S1.

A measurement and control system 140 is in communication with the camera 130 and is configured to determine the LCTE of the sample S based on the plurality of images. In experimental configurations, Vic-Snap software was used for capturing the images, and the analysis of the images for DIC was done using Vic-2D, although those having ordinary skill in the art will recognize that other software products may be used for capturing and analyzing the images taken. In some embodiments, a camera controller 132, such as a National instruments NI cDAQ™-9174, is used separately from the measurement and control system 140 to control the acquisition of images at specified temperatures. In some embodiments, an optional secondary viewport 122 is also provided on one side of the chamber 110 to allow for further inspection of the sample S during heating.

With this configuration, in contrast to conventional arrangements, the DIC testing arrangement 100 is configured to interrogate the heated sample S from directly underneath the chamber 110. Interior lighting elements 116 can be provided within the chamber 110 to help illuminate the bottom surface S1 of the sample S, such as on two opposing corners of the viewport 120. In some embodiments, the interior lighting elements 116 are provided on substantially opposite sides of the sample S, such as at opposite corners of the bottom of the chamber 110, to avoid shadows or unnecessary glare on the bottom surface S1 during imaging. In addition, in some embodiments, one or more additional lighting source 117 is also included to further illuminate the sample S, such as on a back-interior wall of the chamber 110. In any configuration, the interior lighting elements 116 and/or the one or more additional lighting source 117 can be selectively turned on while the bottom surface S1 is being imaged but otherwise turned off to prevent the lights from acting as non-uniform sources of heat in the system that could cause uneven heating of the sample S.

With this arrangement, a single camera 130 can be positioned directly beneath the sample S. This camera position and sample placement has at least two main benefits over conventional DIC configurations. A first benefit is that capturing images from a bottom camera position can negate or at least largely minimize any natural convective flow around the face of interest as it is now horizontal. This arrangement is in contrast to the traditional side viewing DIC setup discussed above, in which the vertical surface S0 of the sample S being observed is a surface over which there are natural convective waves moving that can cause significant noise during imaging. A second advantage over a conventional camera setup is that out-of-plane deformations are controlled. It is recognized that at sufficiently high temperatures, material of the sample S may sag into the opening 113 in the platform 112, but those having ordinary skill in the art will recognize that characterizing the LCTE of a material can generally be done at temperatures well below this glass transition, and thus little to no out-of-plane deformation should be observed when using the present test arrangement. Accordingly, using the bottom camera position and sample placement, expansion in the vertical dimension will almost exclusively be relative to the position of the platform 112, and the interrogated bottom surface S1 will not move relative to the camera 130. Thus, by specifying the physical arrangement of the camera 130 and the heated sample S, two major sources of error and system complexity are addressed simultaneously.

As a result, a single camera 130 is able to accurately capture the relevant strain measurements to determine the LCTE of the sample S or otherwise characterize one or more physical property of the sample S. In some embodiments, the DIC testing arrangement 100 disclosed herein can be used to accurately evaluate the combined effects of the printed mesostructure and the fiber-aligned microstructure on the coefficient of thermal expansion of large-scale printed parts.

### III. Methods

To determine one or more physical property of a sample S, methods according to the presently-disclosed subject matter can include positioning the sample S in the temperature-controllable chamber 110. In some embodiments, this positioning can involve placing the sample S on the platform 112 above the bottom viewport 120 with the bottom surface S1 of interest facing down. A plurality of images of the bottom surface S1 can then be captured, and a linear coefficient of thermal expansion of the sample S can be determined based on the plurality of images. In some embodiments, the acquisition of the plurality of images can include capturing one or more first images of the bottom surface S1 at a first temperature to serve as a reference image set. Temperature within the chamber 110 can be changed to a second temperature, and a one or more second images of the bottom surface S1 can be captured at the second temperature. The one or more second images can be compared against the one or more first images to generate associated strain data from which physical properties of the sample S can be determined. For instance, measured strain is divided by the change in temperature to find the coefficient of thermal expansion in the respective direction, as is shown in Equation 1.

$$L C T {E}_{i} = \frac{{ϵ}_{i}^{HighTemp} - {δ}_{i}^{LowTemp}}{Δ T} \qquad [ 1 ]$$

Within this general framework, the parameters for this method can be adapted to characterize the LCTE of the sample S. In particular, in some embodiments the sample S is a cube. The cube axes can be labelled with respect to their print orientation: the x-axis is the primary horizontal print direction, the y-axis is on the same horizontal plane perpendicular to the x-axis, and the z-axis is in the vertical print direction. In embodiments in which the 0-90 cube does not have a primary horizontal print direction (i.e., a direction in which the majority of its layers align), the x-axis can be chosen to be the print direction of the imaged surface. In some embodiments, the one or more first images (e.g., forty-five images) of the sample can be taken at room temperature (e.g., about 20° C.) at a first sampling rate (e.g., 100 ms). The temperature-controllable chamber can then be heated to an elevated temperature (e.g., about 90° C.), and the sample can be allowed to reach equilibrium by resting at the elevated temperature for a defined rest time (e.g., about 24 hours), after which the one or more second images (e.g., another 45 images) can be taken of the sample at a second sampling rate (e.g., 100 ms). The images can then be processed using a desired software product (e.g., Vic-2D software).

In some embodiments, DIC divides the reference image up into a grid. The sizing of this grid is referred to as the subset size and each point where the grid intersects is the center of a subset. In some embodiments, a subset size of 65×65 pixels can be chosen based on Vic-2D's recommendation for the speckling pattern used. The gray intensity of each subset can be calculated and used to track a reference point to its location in the corresponding deformed image. The new and old position of the reference point can be used to calculate a displacement vector. In some embodiments, multiple projections of each displacement vector can be derived to characterize the LCTE of the sample S in different directions. In some particular embodiments, for example, the sample S can be measured twice for CTE: once in a first direction and again in a second direction that is rotated by 90 degrees relative to the first direction. For instance, using the displacement vector, the strain in the x- and y-axes of the camera, which will be referred to as the x′- and y′-axes from now on, can be calculated [23]. In this way, a differential between the LCTE in different directions can be identified, which may be attributed to fiber orientations within the sample S or print direction artifacts. Alternatively or in addition, comparing the calculated values of the LCTE in different directions can further help identify any bias that might be introduced by the arrangement of lighting within the chamber 110, such as due to the relative positioning of the lighting elements 116.

Strain data in the x′- and y′-axes can be collected from each sample S at both the first temperature (e.g., about 20° C.) and the second temperature (e.g., about 90° C.). Strain data from the one or more first images in each direction, x′ and y′, can be averaged at both temperatures, which can thus create four averaged datasets for each sample S. As the sample is at the first temperature in the one or more first photos and is being compared to a photo at the same temperature, any measured strain can simply be treated as noise in the system. Thus, since it is noise (δ), it can be subtracted from the one or more second photos to give an accurate representation of the actual strain due to temperature change at the elevated temperature. Measured strain is divided by the change in temperature to find the coefficient of thermal expansion in the respective direction based on the relationship identified above in Equation 1.

### Examples

The following EXAMPLES provide illustrative embodiments. In light of the present disclosure and the general level of skill in the art, those of skill will appreciate that the following EXAMPLES are intended to be exemplary only and that numerous changes, modifications, and alterations can be employed without departing from the scope of the presently disclosed subject matter.

Three samples were created to be used as tests of the present systems and methods. They were printed on the BAAM system at MDF. The samples were printed from 20% carbon fiber by weight in a matrix of acrylonitrile butadiene styrene (ABS) procured from Techmer PM with the trade name Electrafil J-1200/CF/20. The three samples used in these tests were printed with a 10.2 mm nozzle at 200° C. on the BAAM system. Two large cubes (127 mm×127 mm×127 mm) were printed for DIC, one with raster orientation of 0-0, meaning each layer is formed by straight beads side by side and every layer is in the same direction, and the other with a raster orientation of 0-90, where every layer is still formed by side by side beads but rotated ninety degrees from the previous layer. Both cubes were machined flat on all six faces of the cube. The third sample was a smaller cube (50 mm×50 mm×50 mm) printed with 0-0 raster orientation for machining into TMA samples (10 mm×3 mm×4 mm). For the DIC measurements, the two large cubes were painted white on the faces of interest using high-temperature spray paint and then speckled with black ink using a rubber stamp, with a dot sizing of 0.18 mm, and multiple passes at different angles.

For comparison, thermomechanical analysis is a well-established method of determining the LCTE of a sample in accordance with ASTM standard E831-14, which was used a general guideline during testing. Deviations from the standard required additional information: specimens were dried at 85° C. for 6 hours and placed inside a desiccator to cool to room temperature to ensure no moisture in the samples and only one sample from each position was tested [22]. The tests were conducted on an TA Instruments Q400EM TMA. Two samples (10 mm×3 mm×4 mm) were cut from a single bead of the small-scale sample using a Buehler IsoMet1000 saw. Two samples were taken because fiber orientation within a bead is not uniform, as described in FIG. 3. Variation in fiber orientation will affect the LCTE of the samples, so the sample locations were chosen to try to capture both the highly aligned outer shell and the less aligned core. LCTE was measured once in the x, y, and z directions for each sample between the range of 30° C. to 85° C. using TA Instruments Universal Analysis software, which finds the slope of the dimensional change versus temperature graph between the two temperatures. The average of the two values was calculated for each direction.

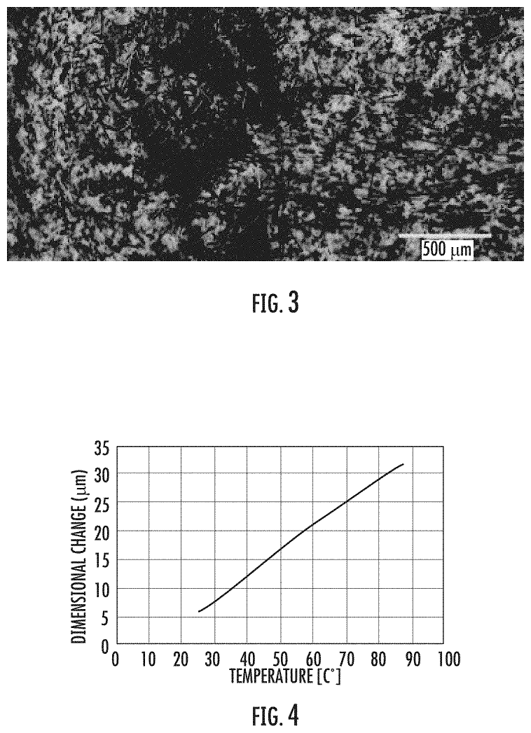

FIG. 4 shows a representative graph of the thermal expansion of a small-scale sample (sample 1) in the x-direction between the temperatures of 30° C. and 85° C. This was done for x- and y-direction in both samples, creating four datasets, and the results can be viewed in Table 1. As expected from literature, the samples do show variance in the same bead. Given LCTE values of the samples, it is likely that sample 2 had high fiber orientation in the x-direction, resulting in the lower value. Large observable differences in LCTE between two samples that are so close together is an indication of how much fiber orientation can vary through a small distance within a bead. Drastic changes in such a short span exhibits the need for multiple samples across a bead to fully understand the thermomechanical behavior of an individual bead, which can then be treated representative of a typical bead. Using accurate data for a representative bead will ensure a higher degree of accuracy in the prediction of LCTE for the part.

TABLE 1
Linear coefficients of thermal expansion measured by TMA

| | X-Axis LCTE | Y-Axis LCTE |
|---|---|---|
| Sample | (μm/m ° C.) | (μm/m ° C.) |
| 1 | 19.41 | 46.23 |
| 2 | 15.93 | 64.87 |
| Average | 17.67 | 55.55 |

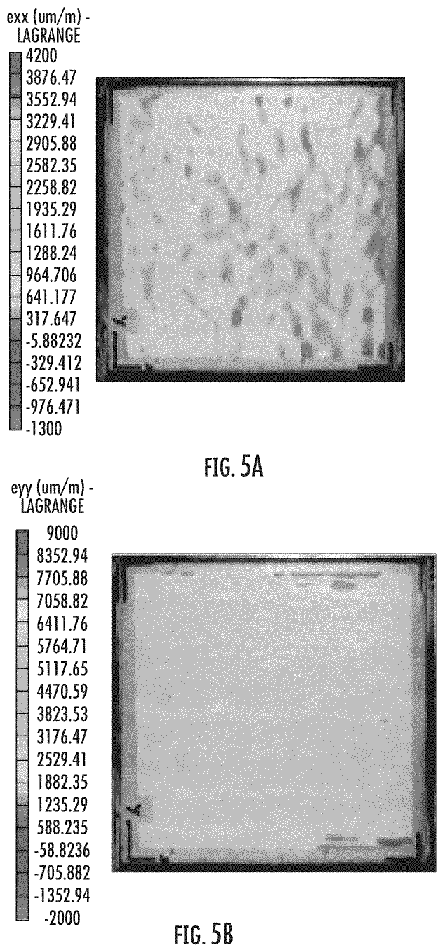

The DIC results were primarily focused on characterizing the LCTE of the material in the two primary directions (x- and y-axes) and documenting their relationship to the raster orientation of the part. FIGS. 5A-5B show the averaged strain maps for the x- and y-directions at 90° C., respectively, after low temperature noise had been subtracted, for the 0-0 cube. The strain maps are not meant for comparison between the two but rather to understand local strains on the surface for each direction. In the 90° C. strain map in the x-direction, there is no pattern to the data, however, when looking at the y-direction strain map, there seems to be slight banding of higher and lower strain areas. These bands of high strain align with bead interfaces, this high strain could be due to the high amount of fibers aligned in the x direction near bead interfaces and thus a lack of fibers oriented in the y direction to keep the matrix from expanding in that direction. Some negative strain can be seen in the 90° C. photos, but these are primarily due to edge effects, print defects, and artifacts on the cube.

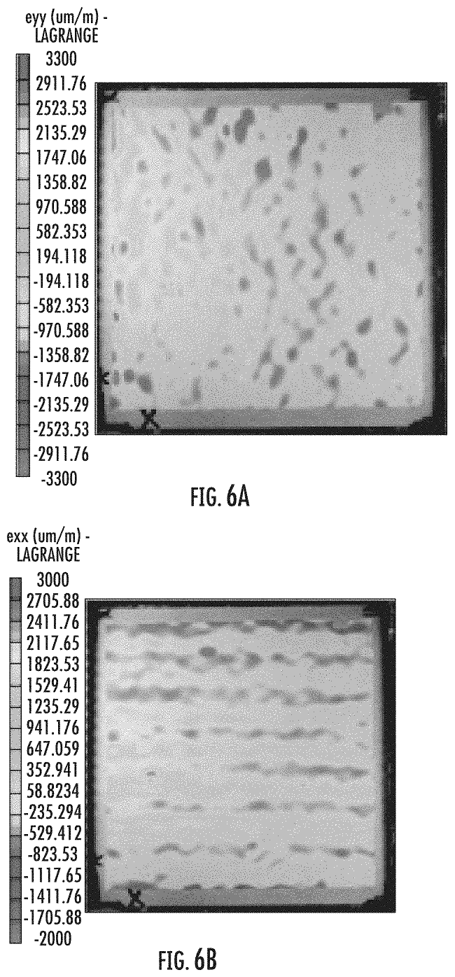

The averaged 90° C. 0-90 cube data can be seen in FIGS. 6A-6B. Again, the 20° C. noise has been subtracted from these photos. It is important to remember in the 0-90 cube that the x- and y-axes are arbitrary. Strain in the y-direction, again shows an easily discernable banded structure that overlays the bead interfaces of the cube, where the areas of higher strain match the bead to bead interfaces. The most likely culprit is either the bead to bead interface itself or the fiber orientation differences between the middle and edge of the beads, but there could be other influencing factors. The y-direction strain map at 90° C. shows no pattern or artifacts in the data.

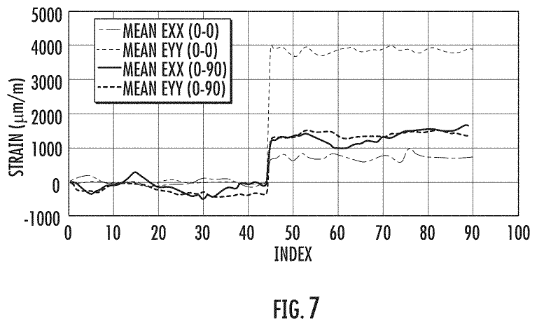

The average noise at 20° C. and strain at 90° C. of each of the images was graphed for both cubes in FIG. 7. There is a large disparity between the x and y average strain in the 0-0 cube, which is a result of all the layers in the 0-0 cube expanding in a similar pattern of low expansion in the print direction due to the high orientation of fibers and a higher expansion in the y-direction. A different result is achieved due to these highly aligned fibers in the print direction in the 0-90 cube, as layers in the 0-90 cube are expanding perpendicularly to each other and thus causing a LCTE mismatch with adjacent layers. The strain data was collected for the x-z plane and the y-z plane of each of the cubes, ensuring both the x- and y-directions had strain data collected as both the x′- and y′-direction in the photo, and the two numbers were averaged to reduce biasing from measurement. This data can be seen in Table 2. The x and y LCTE are within 1% of each other in the 0-90, which is significantly closer than the LCTE in the 0-0 cube. This finding indicates that manipulation of raster orientation could possibly be used to control x and y LCTE of LAEDAM parts.

TABLE 2
Calculated linear coefficients of thermal expansion using DIC

| | | | |
|---|---|---|---|
| | Strain | X-Axis LCTE | Y-Axis LCTE |
| Sample | Direction | (μm/m ° C.) | (μm/m ° C.) |

| | | | | | |
|---|---|---|---|---|---|
| 0-0 | Exx | 12.4 | 14.4 | 57.3 | 57.7 |
| | Eyy | 16.3 | | 58.0 | |
| 0-90 | Exx | 23.0 | 23.7 | 20.5 | 23.8 |
| | Eyy | 24.4 | | 27.0 | |

Measured values compare closely to predictions based on laminate theory using the anisotropic material properties at the microscale for common raster orientations. Analogies for comparing short-fiber reinforced composites to laminates are not a new idea. Halpin and Pagano described a method in 1969 of treating randomly oriented short-fiber reinforced composites as laminates by describing them as quasi-isotropic laminates to predict mechanical behavior [24]. Halpin's work, along with others from that time, proved the applicability of using composite laminate theory on other types of composites if an analogy could be made between the two. Parts with simple angled raster patterns produced using AM and continuous fiber laminates have some similarities: the mechanical properties of each is related to the macrostructure of the part or laminate and each have high stiffness regions (continuous fibers in laminates and bead interfaces where fibers are highly aligned). Given these similarities, this study will assess the applicability of using elementary composite laminate theory to predict the LCTE of a cube with raster orientation of 0-90. The theory was not applied to the 0-0 case as it will only return the LCTE used as the material properties since it is a trivial case where all lamina are aligned.

To apply laminate theory to the cubes, the following assumptions were applied: each layer in the printed part is analogous to an orthotropic continuous fiber lamina with the same orientation and material properties, stresses in z direction are negligible, the x-direction is the 1-direction, the y-direction is the 2-direction and the thickness dimension is much smaller than the length or width dimensions [25]. Before calculations could start necessary material properties were measured, α₁ and α₂, or obtained from other works, E₁, E₂, v₁₂, v₂₁ and G₁₂ [10, 25, 26]. It is worth noting that the Poisson's ratios and shear modulus were from 15% weight carbon fiber ABS and the difference could be reflected in the data. The steps for calculating the LCTE of the part as a whole start with the calculation of the stiffness matrix, [Q], of the lamina, which is based entirely on its material properties. Following this the [A], [B] and [D] matrices, or in physical terms the extensional stiffness matrix, coupling stiffness matrix, and bending stiffness matrix, respectively, are calculated. Next, the [N] matrix, stress resultant matrix, and [M] matrix, moment resultant matrix, were calculated using the LCTE and the relevant temperature range. These, along with matrix manipulation of the [A], [B] and [D] matrices, are used to calculate the LCTE of the laminate. The full process can be seen in Daniel's text [25]. When laminate theory was applied to the 0-90 cube, the x-axis and y-axis LCTE were calculated to be 28.39 μm/m° C. and 28.39 μm/m° C. respectively, which is as one would expect for 0-90 and an even number of layers (24 in this case).

TABLE 3
Comparison of laminate theory and DIC LCTE

| | Laminate Theory | | DIC | |
|---|---|---|---|---|
| | X-Axis LCTE | Y-Axis LCTE | X-Axis LCTE | Y-Axis LCTE |
| | (μm/m ° C.) | (μm/m ° C.) | (μm/m ° C.) | (μm/m ° C.) |
| 0-0 | 17.7 | 55.6 | 14.4 | 57.7 |
| 0-90 | 28.9 | 28.9 | 23.7 | 23.8 |

### CONCLUSIONS

The present subject matter provides systems and methods regarding the use of DIC to measure strain in a LAEDAM part as well as the applicability of laminate theory combined with measured LCTE from TMA testing. The DIC testing showed not only an accurate measurement of the strain in the part, values shown again in Table 3, but it also showed that print artifacts can be seen in the strain maps. TMA test data are valuable for understanding the variation of LCTE across the bead and can serve as an estimate for a whole part printed with a 0-0 orientation, as can be seen in the 0-0 section under laminate theory in Table 3 as laminate theory of a unidirectional composite will just return the LCTE input. These results will most likely more closely resemble the DIC data if the bead's LCTE is characterized more accurately. TMA data, even when combined with the laminate theory and chosen assumptions, is only suited for a rough prediction of the LCTE of a part with alternating angled raster orientations. This could be resultant of, again, more in-depth LCTE for the bead, poor assumptions, or due to some inaccurate properties as mentioned before. In reality it is most likely some mixture of all three. The 0-90 cube did show the same behavior in both the DIC and laminate theory, though as expected the LCTE in the x- and y-direction match. Until further investigation into accurately predicting LCTE of a part using TMA data is accomplished, its limitations make DIC the most reliable way to obtain LCTE values of a part.

### REFERENCES

1. Mieloszyk, J., A. Tarnowski, M. Kowalik, R. Perz, and W. Rzadkowski, Preliminary design of 3D printed fittings for UAV. Aircraft Engineering and Aerospace Technology, 2019. https://doi.org/10.1108/AEAT-07-2018-0182
2. Kasparova, M., L. Grafova, P. Dvorak, T. Dostalova, A. Prochazka, H. Eliasova, J. Prusa, and S. Kakawand, Possibility of reconstruction of dental plaster cast from
3D digital study models. BioMedical Engineering OnLine, 2013. 12(1): p. 49. https://doi.org/10.1186/1475-925x-12-49
3. Skowyra, J., K. Pietrzak, and M. A. Alhnan, Fabrication of extended-release patient-tailored prednisolone tablets via fused deposition modelling (FDM) 3D printing. European Journal of Pharmaceutical Sciences, 2015. 68: p. 11-17. https://doi.org/10.1016/j.ejps.2014.11.009
4. Hassen, A. A., R. Springfield, J. Lindahl, B. Post, L. Love, C. Duty, U. Vaidya, R. B. Pipes, and V. Kunc. The durability of large-scale additive manufacturing composite molds. in Composites and Advanced Materials Expo (CAMX) Conference. 2016.
5. Hassen, A. A., J. Lindahl, X. Chen, B. Post, L. Love, and V. Kunc. Additive manufacturing of composite tooling using high temperature thermoplastic materials. in SAMPE Conference Proceedings, Long Beach, Calif., May. 2016.
6. Kunc, V., J. Lindah, R. B. Dinwiddie, B. K. Post, L. J. Love, C. Duty, M. Matlack, R. Fahey Jr, and A. A. Hassen. Investigation of In-autoclave Additive Manufacturing Composite Tooling. in CAMX Conference, Anaheim, Calif. 2016.
7. Sudbury, T. Z., R. Springfield, V. Kunc, and C. Duty, An assessment of additive manufactured molds for hand-laid fiber reinforced composites. The International Journal of Advanced Manufacturing Technology, 2017. 90(5): p. 1659-1664. https://doi.org/10.1007/s00170-016-9464-9
8. Masood, S. and W. Song, Development of new metal/polymer materials for rapid tooling using fused deposition modelling. Materials & design, 2004. 25(7): p. 587-594.
9. Twigg, G., A. Poursartip, and G. Fernlund, Tool-part interaction in composites processing. Part I: experimental investigation and analytical model. Composites Part A: Applied Science and Manufacturing, 2004. 35(1): p. 121-133. https://doi.org/10.1016/S1359-835X(03)00131-3
10. Hill, C., K. Rowe, R. Bedsole, J. Earle, and V. Kunc, Materials and Process Development for Direct Digital Manufacturing of Vehicles. 2016.
11. Sung-Hoon, A., M. Michael, O. Dan, R. Shad, and K. W. Paul, Anisotropic material properties of fused deposition modeling ABS. Rapid Prototyping Journal, 2002. 8(4): p. 248-257. https://doi.org/10.1108/13552540210441166
12. Zaldivar, R. J., D. B. Witkin, T. McLouth, D. N. Patel, K. Schmitt, and J. P. Nokes, Influence of processing and orientation print effects on the mechanical and thermal behavior of 3D-Printed ULTEM® 9085 Material. Additive Manufacturing, 2017. 13: p. 71-80. https://doi.org/10.1016/j.addma.2016.11.007
13. Velez-Garcia, G., A. Wright, V. Kunc, and C. Duty, Coefficient of Thermal Expanstion Test Report. ORNL Technical Report, 2014. ORNL/TM-2014/334.
14. Love, L. J., V. Kunc, O. Rios, C. E. Duty, A. M. Elliott, B. K. Post, R. J. Smith, and C. A. Blue, The importance of carbon fiber to polymer additive manufacturing. Journal of Materials Research, 2014. 29(17): p. 1893-1898. https://doi.org/10.1557/jmr.2014.212
15. Duty, C. E., T. Drye, and A. Franc, Material Development for Tooling Applications Using Big Area Additive Manufacturing (BAAM). 2015, Oak Ridge National Lab. (ORNL), Oak Ridge, Tenn. (United States). Manufacturing Demonstration Facility (MDF). p. Medium: ED.
16. Lhotellier, F. C. and H. F. Brinson, Matrix-fiber stress transfer in composite materials: Elasto-plastic model with an interphase layer. Composite Structures, 1988. 10(4): p. 281-301. https://doi.org/10.1016/0263-8223(88)90007-4
17. Advani, S. G. and C. L. T. III, The Use of Tensors to Describe and Predict Fiber Orientation in Short Fiber Composites. Journal of Rheology, 1987. 31(8): p. 751-784. https://doi.org/10.1122/1.549945
18. Affdl, J. C. H. and J. L. Kardos, The Halpin-Tsai equations: A review. Polymer Engineering & Science, 1976. 16(5): p. 344-352. https://doi.org/10.1002/pen.760160512
19. E. Verweyst, B. and C. Tucker, Fiber Suspensions in Complex Geometries: Flow/Orientation Coupling. Vol. 80. 2002. 1093-1106.
20. Tekinalp, H. L., V. Kunc, G. M. Velez-Garcia, C. E. Duty, L. J. Love, A. K. Naskar, C. A. Blue, and S. Ozcan, Highly oriented carbon fiber-polymer composites via additive manufacturing. Composites Science and Technology, 2014. 105: p. 144-150. https://doi.org/10.1016/j.compscitech.2014.10.009
21. Laboratory, O. R. N., Manufacturing Demonstration Facility Annual Report: Polymer Additive Manufacturing, D.o. Energy, Editor. 2014: Oak Ridge, Tenn.
22. ASTM E831-14, Standard Test Method for Linear Thermal Expansion of Solid Materials by Thermomechanical Analysis. 2019, ASTM International, West Conshohocken, Pa., 2014.
23. Pan, B., K. Qian, H. Xie, and A. Asundi, Two-dimensional digital image correlation for in-plane displacement and strain measurement: a review. Measurement Science and Technology, 2009. 20(6): p. 062001. https://doi.org/10.1088/0957-0233/20/6/062001
24. Halpin, J. C. and N. J. Pagano, The Laminate Approximation for Randomly Oriented Fibrous Composites. Journal of Composite Materials, 1969. 3(4): p. 720-724. https://doi.org/10.1177/002199836900300416
25. Daniel, I. M. and O. Ishai, Engineering mechanics of composite materials. 2nd ed. 2006, New York: Oxford University Press. xviii, 411 p.
26. Zhang, W., C. Cotton, J. Sun, D. Heider, B. Gu, B. Sun, and T.-W. Chou, Interfacial bonding strength of short carbon fiber/acrylonitrile-butadiene-styrene composites fabricated by fused deposition modeling. Composites Part B: Engineering, 2018. 137: p. 51-59. https://doi.org/10.1016/j.compositesb.2017.11.018.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A system for determining a physical property of a sample, the system comprising:
a temperature-controllable chamber comprising:
a platform having an opening therethrough; and
a viewport in a bottom of the chamber;
a camera positioned beneath the chamber, wherein the camera is configured to capture a plurality of images of a sample positioned on the platform over the opening;
a temperature control system in communication with the chamber and configured to modulate a temperature within the chamber; and
a measurement and control system in communication with the camera and configured to characterize one or more physical property of the sample based on the plurality of images.

2. The system of claim 1, wherein the chamber comprises a secondary viewport arranged on a side of the chamber.

3. The system of claim 1, wherein the chamber comprises one or more interior lighting elements positioned about the opening in the platform.

4. The system of claim 3, wherein the one or more interior lighting elements is positioned inside the chamber beneath the platform.

5. The system of claim 1, wherein the controller is configured to apply a digital image correlation technique to characterize the one or more physical property of the sample based on the plurality of images.

6. The system of claim 1, comprising a camera controller connected to the camera and configured to control acquisition of the plurality of images.

7. The system of claim 1, wherein the sample comprises a component produced by large area extrusion deposition additive manufacturing.

8. The system of claim 1, wherein the one or more physical property comprises a linear coefficient of thermal expansion of the sample.

9. A method for determining a physical property of a sample, the method comprising:
positioning a sample in a temperature-controllable chamber comprising a viewport in a bottom of the chamber;
capturing a plurality of images of a bottom surface of the sample; and
characterizing one or more physical property of the sample based on the plurality of images.

10. The method of claim 9, wherein the sample comprises a component produced by large area extrusion deposition additive manufacturing.

11. The method of claim 9, wherein the chamber comprises a platform having an opening therethrough; and
wherein positioning the sample in the chamber comprises positioning the sample on a platform over the opening.

12. The method of claim 9, comprising illuminating the bottom surface of the sample using one or more interior lighting elements positioned inside the chamber.

13. The method of claim 9, wherein capturing the plurality of images of the bottom surface of the sample comprises:
setting a temperature inside the chamber to a first temperature;
capturing one or more first images at the first temperature;
changing the temperature within the chamber to a second temperature; and
capturing one or more second images at the second temperature.

14. The method of claim 13, wherein characterizing one or more physical property of the sample based on the plurality of images comprises:
comparing the one or more second images against the one or more first images to generate associated strain data; and
determining a linear coefficient of thermal expansion based on a relationship between the associated strain data and a difference between the first temperature and the second temperature.

15. The method of claim 14, wherein comparing the one or more second images against the one or more first images comprises:
generating a first set of strain data with respect to a first reference axis; and
generating a second set of strain data with respect to a second reference axis that is perpendicular to the first reference axis.

16. The method of claim 9, wherein charactering one or more physical property of the sample comprises applying a digital image correlation technique.
